(19) United States
(12) Patent Application Publication
(10) Pub. No.: US 2016/0328443 A1
(43) Pub. Date: Nov. 10, 2016

(54) Knowledge Graph Based Query Generation

(71) Applicant: Vero Analytics, Inc., Vienna, VA (US)

(72) Inventors: Ajo P. ABRAHAM, Vienna, VA (US); Yulin Wen, Taipei (TW); Tai Hu, Clarksburg, MD (US)

(73) Assignee: Vero Analytics, Inc., Vienna, VA (US)

(21) Appl. No.: 15/136,579

(22) Filed: Apr. 22, 2016

Related U.S. Application Data
(60) Provisional application No. 62/157,852, filed on May 6, 2015.

(51) Int. Cl. G06F 17/30

(52) U.S. Cl. CPC G06F 17/30442; G06F 17/30401; G06F 17/30339; G06F 17/30958

(57) ABSTRACT

Computer-implemented methods, systems and program storage devices for knowledge graph based query generation are disclosed herein. A computer-implemented method includes storing electronically a knowledge graph that represents relationships between a plurality of knowledge models. Further steps include: receiving a query specification that identifies a knowledge model for a query dataset; determining with a computing device a path based on path cost criteria, where the path covers a portion of the knowledge graph across one or more knowledge models to one or more data sources; and generating an initial query plan according to one or more knowledge models along the determined path to fulfill the query specification with data from one or more data sources.

### CROSS REFERENCE TO RELATED APPLICATIONS

This application claims the benefit under 35 U.S.C. §119(e) of U.S. provisional patent application Ser. No. 62/157,852, filed May 6, 2015, which is incorporated herein by reference in its entirety.

### BACKGROUND OF THE INVENTION

1. Field of the Invention

This technological field generally relates to data source query generation.

2. Related Art

Various types of data sources exist, including relational databases, NoSQL databases, and big data sources. Data sources may organize data into tables, where each table may have rows and columns. Each row may represent a record. Each column may have entries for each record of the same data type. A data type may be, for example, a text string, number, or date.

Two example tables—a revenue table and a profit table—are reproduced below. In this example, each table has four columns, three of which are the same: date, product, and customer. Each table also has a column not shared by the other. In particular, for each record, the revenue table has a revenue entry, and the profit table has a profit entry.

Below is an example revenue table, which may be referred to below as Revenue_Fact:

| Date | Product | Customer | Revenue |
|---|---|---|---|
| Jan. 1, 2014 | Chair | Jay | 10 |
| Jan. 1, 2014 | Chair | Alex | 50 |
| Jan. 1, 2014 | Desk | Alex | 100 |
| Jan. 25, 2014 | Lamp | Jay | 10 |
| Jan. 2, 2014 | Desk | Jane | 100 |
| Jan. 2, 2014 | Lamp | Roger | 5 |
| Jan. 10, 2014 | Chair | Roger | 25 |

Below is an example profit table, which may be referred to below as Profit_Fact:

| Date | Product | Customer | Profit |
|---|---|---|---|
| Jan. 1, 2014 | Chair | Jay | 5 |
| Jan. 1, 2014 | Chair | Alex | 40 |
| Jan. 1, 2014 | Desk | Alex | 75 |
| Jan. 25, 2014 | Lamp | Jay | 5 |
| Jan. 2, 2014 | Desk | Jane | 75 |
| Jan. 2, 2014 | Lamp | Roger | 1 |
| Jan. 10, 2014 | Chair | Roger | 10 |

Data analysis tools may be used to retrieve data. To retrieve data, data analysis tools may filter data by entities, such as dimension entities and measure entities. Dimensions may refer to entities by which a user wants to group data. For example, in the above tables, Date, Customer, and Product may be dimension entities because those are fields by which data can be grouped. For example, to determine the total revenue for each product in the Revenue_Fact table, the records must be grouped on product. Because all the records in the table have one of three products (chair, lamp, and desk), the result may have three rows, each listing the total revenue for one of the three products.

Measure entities may refer to formulas (also called equations) calculated by applying an aggregation function to a column in a database table. An aggregation function examines multiple rows of a table, perhaps in a group, as an input to determine a value. For example, a measure entity to determine total revenue may have the formula sum(revenue). If the records are grouped by product, the result may be the total revenue provided by each product. In addition to sum, other example aggregation functions include, but are not limited to, average, count, maximum, minimum, median, and mode.

One widely adopted way to retrieve data from databases is to use structured query language (SQL). SQL is the primary way that data analysts, data engineers, and data scientists access data stored in relational data sources (RDBMS) and even some big data sources.

SQL can be quite sophisticated and complex. To help users manage the complexity, many data analysis tools help a user input or select an SQL query. Returning to the example above, to determine the total revenue provided by each product, the following SQL query may be used:

```
Select
    Product,
    sum(revenue)
From
    Revenue_Fact
Group By
    Product
```

SQL provides two primary ways of filtering out records: the WHERE clause and the HAVING clause. In the example above, a filter may be used to identify which products have a total profit exceeding 10. In SQL, the filter may be represented using a HAVING clause, as set out below:

```
Select
    Product,
From
    Profit_Fact
Group By
    Product
Having
    Sum(profit)>10 )
```

While SQL is quite expressive and easy in simple scenarios, it can get quite complex and even inaccessible to novice users. For some user questions, multiple queries may be needed of the database. These may be referred to as multi-pass queries. But often these multi-pass queries are inefficient. Methods and systems are still needed to improve multi-pass query processing. Additionally, as SQL scripts proliferate in an organization it becomes increasingly difficult to manage and propagate changes in the underlying data sources to the scripts with hard coded references.

Traditional business intelligence (BI) tools like the SAP Business Objects product, Microstrategy Analytics product, and Oracle OBIEE product emerged to solve some of these issues. These tools sometimes can generate complex analytical SQL queries but at a high cost in user time and experience. Setting up queries had to be carried out and fixed in advance by users. Numerous inefficiencies arose when queries required a tool to access data drawn from different data sources with different potential paths to access the data. Very experienced users with deep knowledge of a particular query, required data sources, and necessary paths to fulfill different expressions of the query could help manually create a more efficient query. But writing such a query was burdensome, inflexible, and required a steep learning curve.

Drag and drop user interfaces sometimes helped a user create a SQL query but they too did not overcome the challenges of complex SQL queries, multi-pass query processing, or the requirement that a user have deep knowledge of a dataset to fix and identify a query in advance.

These problems worsen as queries use more complicated filters with measure entities and dimension entities that draw from different data sources.

### BRIEF SUMMARY OF THE INVENTION

Computer-implemented methods, systems, and computer program storage devices are needed for query generation.

In an embodiment, a computer-implemented method generates knowledge graph (also referred to as semantic graph) based queries. A computer-implemented method includes storing electronically a knowledge graph that represents relationships between a plurality of knowledge models (also referred to as semantic models). Further steps include receiving a query specification that identifies a knowledge model for a query dataset and determining with a computing device a path based on path cost criteria. The path covers a portion of the knowledge graph across one or more knowledge models to one or more data sources. The method includes generating an initial query plan according to one or more knowledge models along the determined path to fulfill the query specification with data from one or more data sources.

In a further feature, the method includes translating the initial query plan to a final query plan expressed in one or more languages compliant with native languages of data sources used to fulfill the query dataset.

System and program storage device embodiments are also disclosed.

Further embodiments, features, and advantages of the invention, as well as the structure and operation of the various embodiments, are described in detail below with reference to accompanying drawings.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art to make and use the disclosure.

FIG. 1 is a diagram illustrating a system that generates queries of data stored in remote data sources over a network according to an embodiment of the present invention.

FIG. 2A is a diagram the illustrates a measure knowledge model according to an example.

FIG. 2B is a diagram the illustrates a dimension knowledge model according to an example.

FIG. 3 is a flowchart illustrating a computer-implemented method for generating queries of data stored in remote data sources over a network according to an embodiment of the present invention.

FIG. 4 is a flowchart illustrating a path determination step of FIG. 3 in further detail according to an embodiment.

FIG. 5 is a flowchart illustrating a computer-implemented method for enabling a user to input a query specification according to an embodiment.

FIG. 6 is a screen shot diagram illustrating a user interface display that provides an intermediate graphical representation of a knowledge graph used in query planning according to an embodiment.

FIG. 7 is a diagram that illustrates example query and result blocks processed in query planning according to an embodiment.

FIG. 8 is a diagram that illustrates example query and result blocks along with engine blocks processed in a query plan with disjoint paths through a knowledge graph according to an embodiment.

FIG. 9 shows an example knowledge graph used in the example of FIG. 8.

FIG. 10 shows an example traversal of the knowledge graph of FIG. 9 to process an engine block for a cost entity in a query plan with disjoint paths.

FIG. 11 shows an example traversal of the knowledge graph of FIG. 9 to process an engine block for a profit entity in a query plan with disjoint paths.

FIG. 12 shows an example traversal of the knowledge graph of FIG. 9 to process a query block for a total category entity in a query plan with disjoint paths.

FIG. 13 shows an example of a knowledge graph edited to include a new dimension entity (cat_name) according to an embodiment.

FIG. 14 shows an example of a knowledge graph edited to rename the new dimension entity (cat_name) to an existing entity name according to an embodiment.

FIG. 15 shows an example of a knowledge graph edited to restructure the path for the new dimension entity (cat_name) to the existing entity according to an embodiment.

FIG. 16 shows how a query plan is updated to reflect a more efficient path over the edited knowledge graph according to an embodiment.

FIGS. 17-19 are screen shot diagrams illustrating different user interface displays according to an embodiment. FIG. 17 shows an intermediate graphical representation of a knowledge graph in a plan view for a result block used in query planning. FIG. 18 shows an intermediate graphical representation of a knowledge graph in a plan view for the result block of FIG. 17 where further filtering criteria is selected in query planning. FIG. 19 shows an intermediate graphical representation of a knowledge graph in a flow view for the result block of FIG. 17 where further filtering criteria is selected in query planning.

FIG. 20 is a diagram illustrating an expression engine that can be implemented with a system that generates queries of data stored in remote data sources over a network according to a further embodiment of the present invention.

FIG. 21 is a diagram of a computing device that can be used in according with an embodiment.

Further embodiments, features, and advantages of the invention, as well as the structure and operation of the various embodiments, are described in detail below with reference to accompanying drawings. The drawing in which an element first appears is typically indicated by the leftmost digit or digits in the corresponding reference number. In the drawings, like reference numbers may indicate identical or functionally similar elements.

### DETAILED DESCRIPTION OF THE INVENTION

The present disclosure describes innovative technological uses of query planning with a knowledge graph across one or more knowledge models (KMs) to generate queries of data sources. This can include examples where a knowledge model has multiple paths through multiple expressions to database tables on the same or different data sources. In embodiments of the present invention, computer-implemented methods, systems and computer program storage devices are described which use a knowledge graph across one or more knowledge models to generate queries of data sources.

In an embodiment, a knowledge graph engine stores a knowledge graph including one or more knowledge models. The knowledge graph engine includes a query planner and a query translator. Traversing the knowledge graph allows the query planner to efficiently calculate query plans between knowledge models using efficient graph algorithms (such as a shortest distance algorithm). In an embodiment, a path is determined based on path cost criteria.

In a further feature, the query translator generates queries expressed in one or more languages compliant with respective data sources. These can include current or future languages used to access data from the data sources including but not limited to SQL and native application code languages like Java, Python, or Scala.

Table of Contents

Query Generation System
Knowledge Graph Engine
Query Generation Methods
Path Determination Based on Path Cost Criteria
Generating a User Specification and Creating a New Dataset
Providing Graphical Representations To Facilitate Query Planning
Further Examples of Path Determination for a Query Plan
Expression Engine
Collaboration Engine
Additional Example Computing Device Implementations

Query Generation System

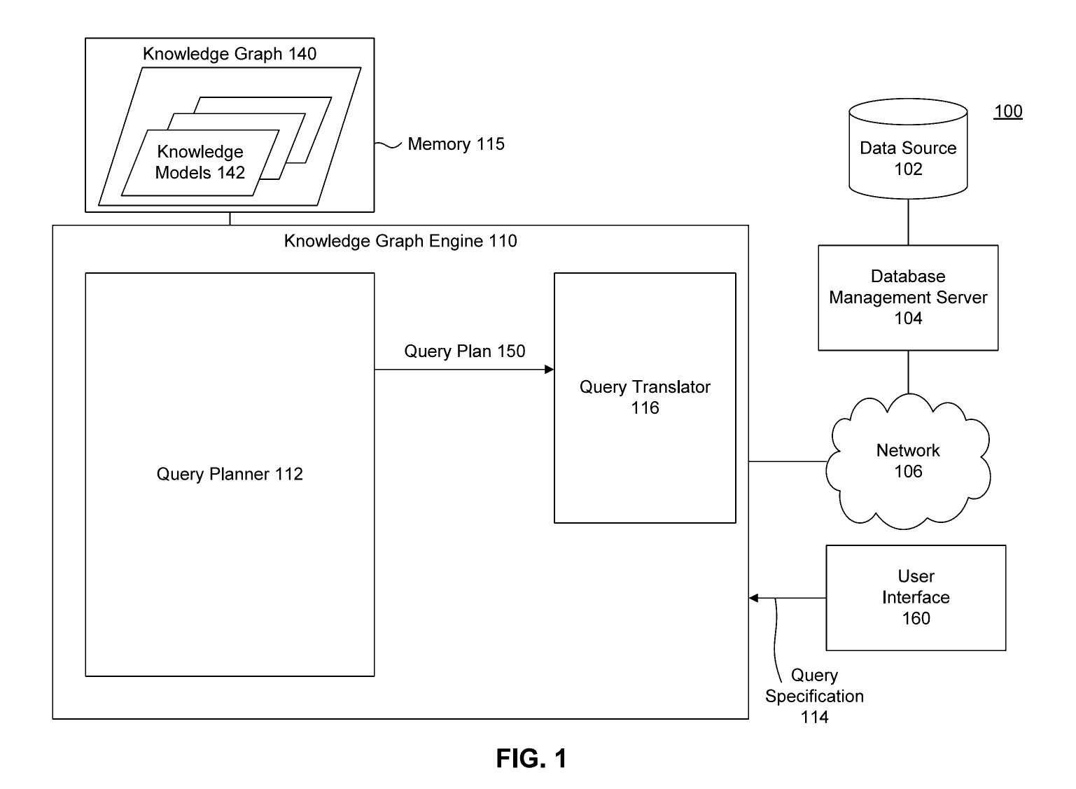

FIG. 1 is a diagram illustrating a system 100 that generates queries of data stored in remote data sources over a network according to an embodiment of the present invention. System 100 includes a knowledge graph engine 110 coupled over one or more networks 106 to a database management server 104 and data source 102. In one example, database management server 104 manages access to data stored in data source 102.

Data source 102 can be any storage device that stores data records including but not limited to devices that stores a table, relational database, NoSQL database, or a big data source. These data source examples are illustrative and not intended to be limiting. One data source 102 is illustrated for clarity; however, more than one data sources 102 can be coupled to or accessed by knowledge graph engine 110. Data source(s) 102 can be on the same or different computing machines at the same or different locations. Data source(s) 102 can also store the same or different types of data accessible by queries expressed in different native languages.

Database management server 104 is optional. Knowledge graph engine 110 can access data source 102 directly or indirectly with or without database management server 104 depending upon a particular application or configuration.

Network 106 can be any type of computer or telephony network or combination of networks such as the Internet or other area network that provide data communication with knowledge graph engine 110 and database management server 104 or data source 102.

Knowledge Graph Engine

In an embodiment, knowledge graph engine 110 includes query planner 112 and query translator 116. Knowledge graph engine 110 manages a knowledge graph 140 having one more knowledge models 142 stored in memory 115. Knowledge graph engine 110 using query planner 112 and query translator 116 generates a query plan representing a data query to access data in one or more datasets 120 as shown in FIG. 1. Memory 115 can be local or remote from knowledge graph engine 110 and located on the same or different computing devices.

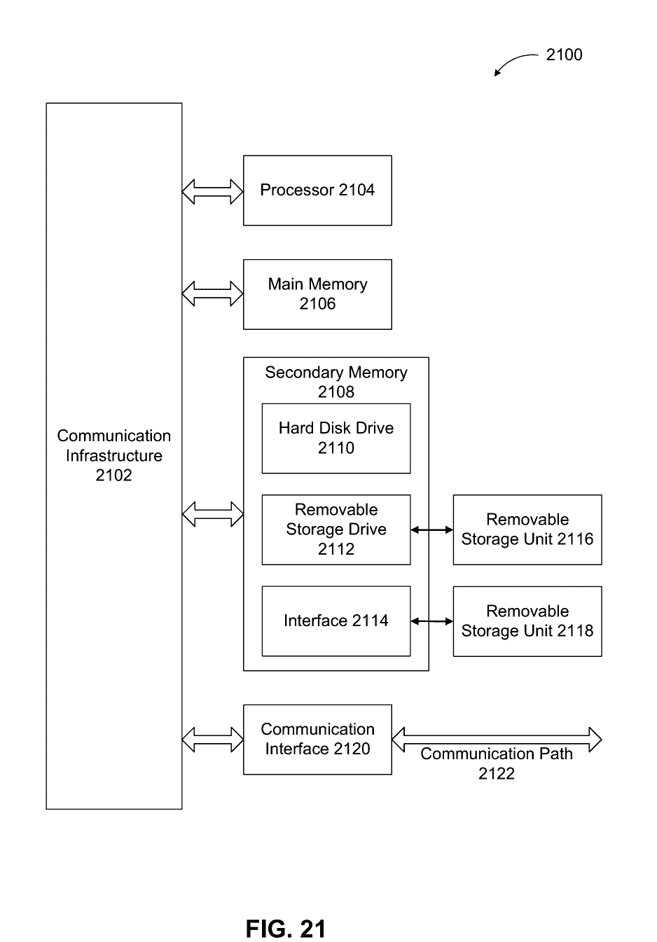

Knowledge graph engine 110 including query planner 112 and query translator 116 can be implemented in hardware, software, firmware, or any combination thereof. Knowledge graph engine 110 including query planner 112 and query translator 116 may be implemented on the same or different computing devices. Such computing devices can include, but are not limited to, a personal computer, a mobile device such as a mobile phone tablet device or laptop device, workstation, embedded system, game console, television, set-top box, or any other computing device. Further, a computing device can include, but is not limited to, a device having a processor and memory, including a non-transitory memory, for executing and storing instructions. The memory may tangibly embody the data and program instructions. Software may include one or more applications and an operating system. Hardware can include, but is not limited to, a processor, a memory, and a graphical user interface display. The computing device may also have multiple processors and multiple shared or separate memory components. For example, the computing device may be a part of or the entirety of a clustered or distributed computing environment or server farm. An example computing device 2100 than can be used is described further with respect to FIG. 21.

Depending upon the particular implementation, the components of knowledge graph engine 110 can be implemented on the same or different computing devices and can be made to operate with a variety of applications. In an example embodiment, knowledge graph engine 110 can be implemented as a client on a computing device and communicate with remote servers over network 106. Knowledge graph engine 110 may be implemented as a client application communicating with other servers such as a host server, or any other client/server configuration. Knowledge graph engine 110 may be implemented a service accessed through a browser in a web service and/or web servers as well. In one example, knowledge graph engine 110 can provide query plans as part of an architecture distributed over one or more networks, such as, for example, a cloud computing architecture. Cloud computing includes but is not limited to distributed network architectures for providing, for example, software as a service (SaaS), infrastructure as a service (IaaS), platform as a service (PaaS), network as a service (NaaS), data as a service (DaaS), database as a service (DBaaS), backend as a service (BaaS), test environment as a service (TEaaS), API as a service (APIaaS), integration platform as a service (IPaaS), etc.

Knowledge model 142 refers to a data structure having entities which have associated data. Such data can include dimensions or measures. A dimension is a category of data. A measure is a value obtained by a calculation or aggregation of data. For clarity, a knowledge model with a dimension is referred to here as a dimension knowledge model. A knowledge model with a measure is referred to here as a measure knowledge model. In one example, a knowledge model includes the name of the entity, a database and table the named entity can be sourced from, and the formula or equation that can be used to source data in the KM. Within a project a single KM can potentially be sourced from many tables and databases and as a result it will have multiple paths and expressions emerging from it. In some cases, a KM expression might be a virtual construct composed across multiple databases and tables.

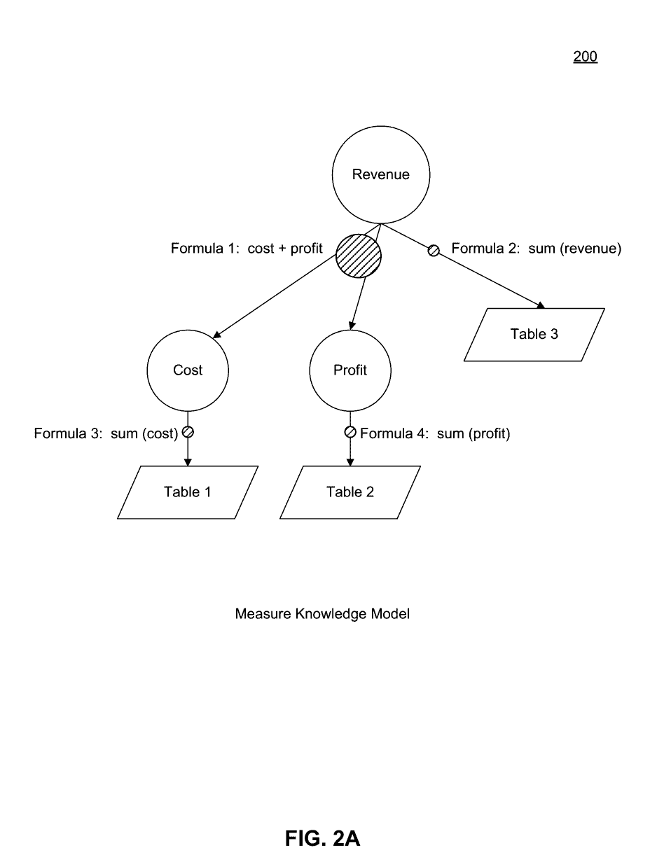

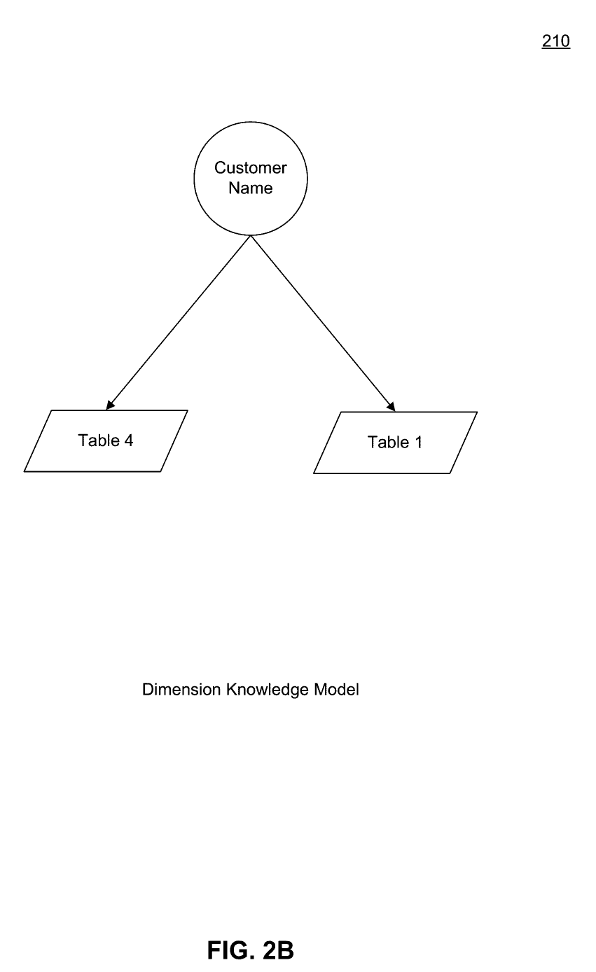

An entity, for example, can be a business entity with associated data (also called business metrics). A business entity can include two KMs for Customer Name data (a dimension) and Revenue data (a measure). As shown in FIG. 2A, measure KM 200 is called Revenue. KM 200 has two alternative paths to access Revenue data: 1) directly queried from Table 3 according to a formula 2: sum (revenue), or 2) composed (according to formula 1: cost+profit) from other KM's Cost and Profit from tables Table1 and Table2 according to respective formulas, formula 3: sum(cost) and formula 4: sum (profit). FIG. 2B shows a dimension KM 210 called Customer Name. Dimension KM 310 has two alternative paths to access customer name data from table 4 and table 1.

According to a feature, knowledge graph engine 110 generates a data query by performing query planning using a knowledge graph that extends across one or more knowledge models.

First, query planner 112 invokes a knowledge graph 140 and accesses a set of desired knowledge models 142. In an embodiment, a query specification 114 is provided to query planner 112. For example, query specification 114 can be created or accessed according to user input at user-interface 160.

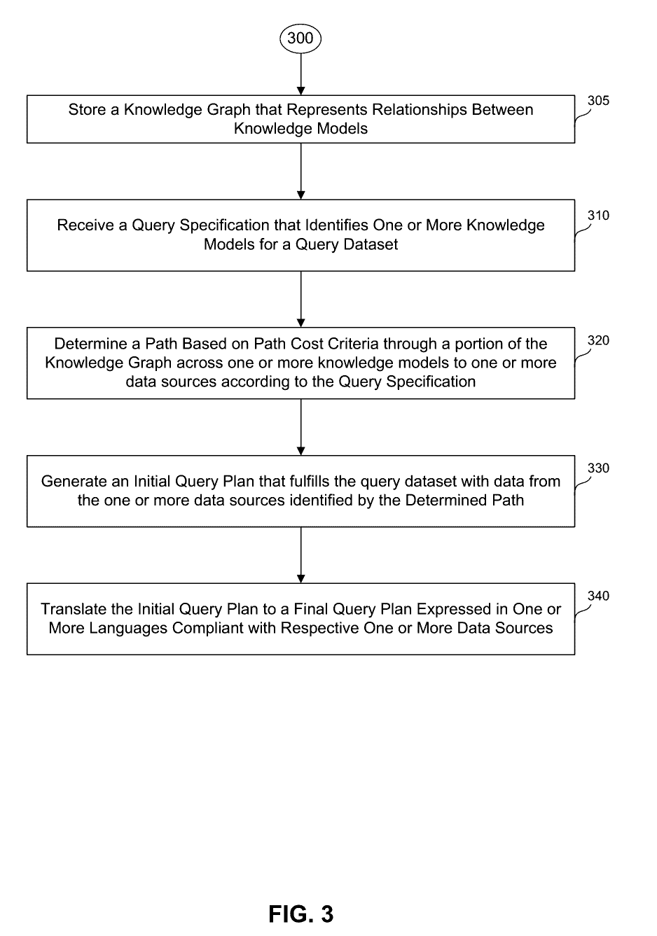

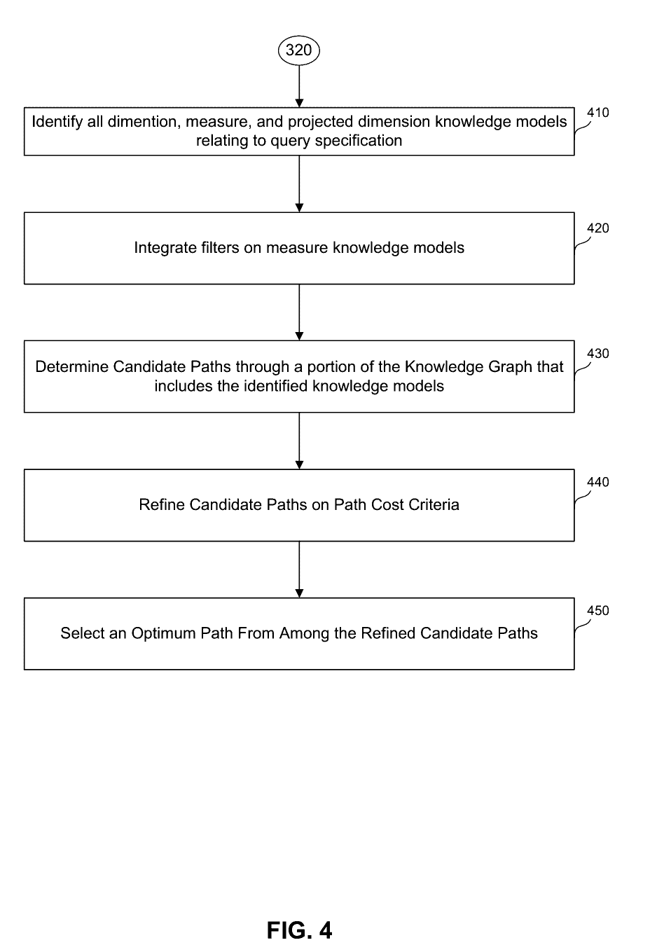

Query planner 112 deploys one or more graph algorithms to traverse knowledge graph 140 and enumerate efficient paths that can satisfy the data request of query specification 114. An efficient path as used herein is a path that is determined according to path cost criteria. In examples, a path is determined based on path cost criteria as described further below and with respect to the methods of FIGS. 3 and 4.

In an embodiment, query planner 112 chooses the most efficient paths in a knowledge graph across one more KMs (e.g., measure KM 200, dimension KM 210) based on one or more of the following path cost criteria: 1) the current query context which is comprised of other KM's requested, 2) the cost of the path individually and collectively with the other KM's, 3) the weight of a path based on user voting of certain changes, and/or 4) table hints currently deployed in the query and prior hinting of table selections.

In one example, query planner 112 operates on one or more query blocks, a result block, and one or more engine blocks. Each query block and result block is processed by query planner 112. A query block identifies one or more measure or dimension KMs. A query block can also include one or more filters, if any, are applied. A result block likewise can include one or more measure or dimension KMs, and one or more filters, if any, are applied. A result block also identifies a particular data source to which a data result is to be stored. When disjoint paths between KMs are encountered in query planning engine blocks (also called set blocks) are created. In determining a path for a query plan, query planner 112 processes each engine block followed by each query block and the result block.

In one example, query planner 112 builds a cost matrix to further refine an optimal candidate path according to path cost criteria. The cost matrix has on its y axis the root tables of potential candidate paths, on its x axis the knowledge models, and within each cell a candidate path. The candidate paths are then refined according to a predetermined optimal strategy.

Stages of refining paths according to an example optimal strategy:
1) Sort the cost matrix by maximum dimensionality;
2) Resolve virtual paths by disassembling them to base components and merge those component paths into the cost matrix;
3) Sort by table hints;
4) Sort by cost;
5) Select measure paths top to bottom until all measures are resolved;
6) Add unresolved dimension models as disjoint paths;
7) Generate 1 or more plan objects;
8) Assemble the plan objects into intermediate query stages (engine blocks) with a final consolidating stage (query block); and
9) Repeat steps for every incoming query and the result block present in a dataset and engine blocks for disjoint paths.

Query planner 112 then outputs to query translator 116 a query plan 150. Query plan 150 represents a data query plan according to the efficient path determined through the knowledge graph based on the knowledge models. Query translator 116 then reviews the target data source 102 and language to generate a data source 102 compliant query in the native language. For example, query translator 116 may retrieve a SQL 99 complaint expression for each knowledge model from query planner 112, parse the expression, and translate the parsed expression to the native language query that is compliant with data source 102.

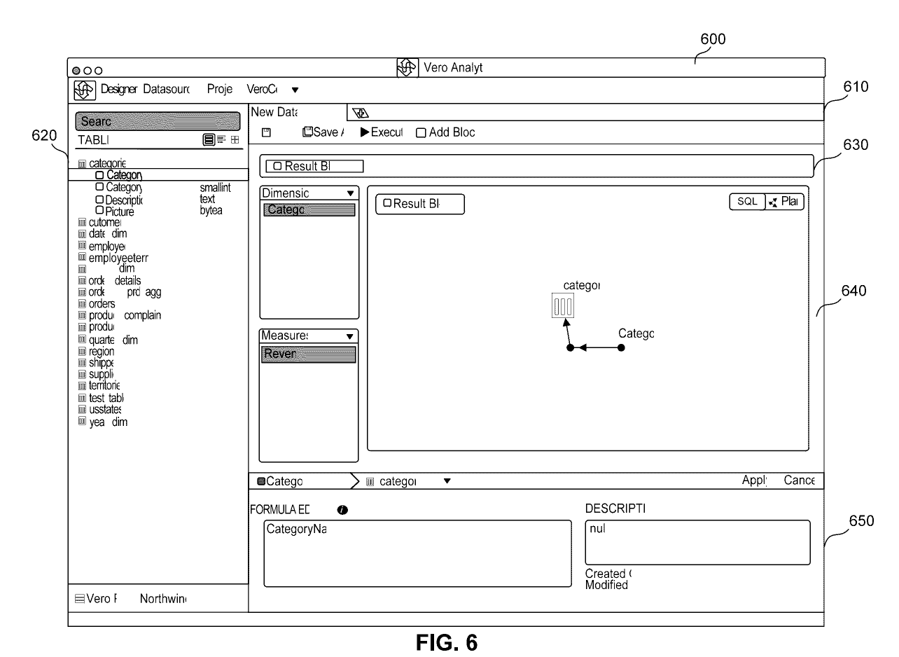

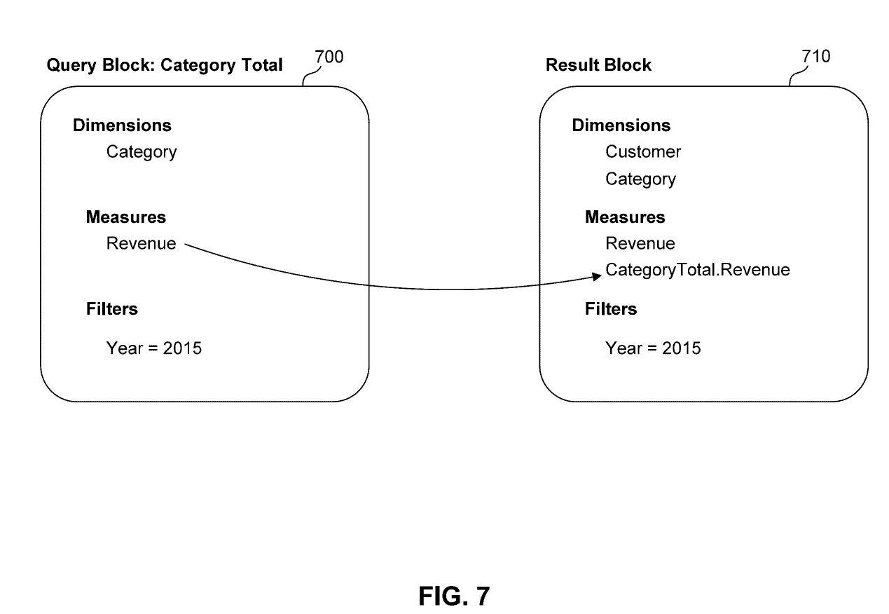

The operation of knowledge graph engine 110 and its components including query planner 112 and query translator 116 are described further below with respect to computer-implemented methods and processes of FIGS. 3-5, graphical display and user-interface panels of FIG. 6, and the example knowledge graph and query, result and engine blocks shown in FIGS. 7-12.

Query Generation Methods

FIG. 3 is a flowchart illustrating a computer-implemented method 300 for generating queries of data stored in remote data sources over a network according to an embodiment of the present invention (steps 305-340). For brevity, method 300 is described with respect to system 100 of FIG. 1. In one embodiment, steps 310-330 can be carried out by query planner 112 on a computing device, and step 340 by query translator 116 on a computing device. Step 305 can be carried out by knowledge graph engine 110 or query planner 112 depending on a desired configuration. However this is illustrative and not intended to limit method 300 which can be carried out in other systems as would be apparent to a person skilled in the art given this description.

In step 305, a knowledge graph 140 is electronically stored. For example, a knowledge graph can be stored in memory 115. The knowledge graph 140 represents relationships across one or more knowledge models 142. In one example, name-based entities are used to facilitate use and recognition by users. For instance, a knowledge graph 140 can include a plurality of knowledge models 142 where each KM describes (i) a name of a data entity that the knowledge model represents; (ii) a database table that provides data for the data entity; and (iii) a formula that describes how to transform data from the database table into data for the data entity, the knowledge graph describing relationships between the knowledge models.

In step 310, a query specification 114 is received that identifies one or more knowledge models for a query dataset. In one embodiment, query specification 114 can identify measure and dimension knowledge models that reference data stored in one or more data sources 102. For example, measure and dimension knowledge models may reference data stored in tables in one or more data sources 102. In one example, block processing in one or more stages is used in query planning. Query specification 114 may then include one or more query blocks and a result block associated with a particular dataset.

Query specification 114 can be received at knowledge graph engine 110 in response to a user selection through a user-interface 160 as shown in FIG. 1 or through other input to a computer-implemented data analytics tool. A user for example can use user-interface 160 to select a dataset and its one or more query blocks and a result block as described further with respect to the user-interface panel 600 of FIG. 6. In other examples, a dataset can also be automatically input or generated by a data analytics tool or in combination with user input associated with a dataset.

In step 320, a path is determined based on path cost criteria. The path covers a portion of the knowledge graph. This graph portion extends across one or more knowledge models to one or more data sources according to the received query specification.

In step 330, an initial query plan is generated based on the determined path. The initial query plan fulfills the received query specification with data from one or more data sources.

In step 340, the initial query plan is translated to a final query plan. The final query plan is expressed in one or more languages compliant with respective native languages of the one or more data sources.

Path Determination Based on Path Cost Criteria

FIG. 4 is a flowchart illustrating a path determination step 320 of FIG. 3 in further detail according to an embodiment (steps 410-450). In one embodiment, steps 410-450 can be carried out by query planner 112 on a computing device.

In step 410, query planner 112 identifies all dimension knowledge models, measure knowledge models, and projected dimension knowledge models relating to an input query specification 114. For example, input query specification 114 may identify any combination of measure or dimension KMs 142. Projected dimension models may also be determined based on the knowledge graph and the relationships between the measure or dimension KMs. A projected dimension KM includes one or more dimensions not present in a set of measure or dimension KMs but projected from evaluating paths through the knowledge graph between the set of measure and dimension KMs where the projected dimensions were encountered.

In step 420, query planner 112 integrates filters on measure knowledge models and reorders the measure knowledge models in a knowledge graph. For example, Boolean reordering can be carried out when a measure knowledge model has a filter for a dimension as described in U.S. Pat. No. 9,092,484, entitled “BOOLEAN REORDERING TO OPTIMIZE MULTI-PASS DATA SOURCE QUERIES,” which is incorporated herein by reference in its entirety. This step is optional and can be omitted if the reordering optimization is not desired.

In step 430, query planner 112 determines candidate paths through a portion of the knowledge graph that includes the identified knowledge models of step 410 with or without the further filtering of step 420. One or more graphing algorithms can be used to traverse the knowledge graph and find candidate paths. This includes identifying where a query plan can have a candidate path joining knowledge models and related derived dimension or derived measures that occur. This also includes identifying disjoint knowledge models where a valid path connects them.

In step 440, query planner 112 refines the candidate paths based on path cost criteria. In embodiment query planner 112 chooses the most optimal paths in a knowledge graph across one more KMs (e.g., measure KM 200, dimension KM 210) based on one or more of the following path cost criteria: 1) the current query context which is comprised of other KM's requested, 2) the cost of the path individually and collectively with the other KM's, 3) the weight of a path based on user voting of certain changes, and/or 4) table hints currently deployed in the query and prior hinting of table selections.

In one example, query planner 112 builds a cost matrix to further refine an optimal candidate path according to path cost criteria. The cost matrix has on its y axis the root tables of potential candidate paths, on its x axis the knowledge models, and within each cell a candidate path. The candidate paths are then refined according to a predetermined optimal strategy.

Stages of refining paths according to an example optimal strategy:
10) Sort the cost matrix by maximum dimensionality;
11) Resolve virtual paths by disassembling them to base components and merge those component paths into the cost matrix;
12) Sort by table hints;
13) Sort by cost;
14) Select measure paths top to bottom until all measures are resolved;
15) Add unresolved dimension models as disjoint paths;
16) Generate 1 or more plan objects;
17) Assemble the plan objects into intermediate query stages (engine blocks) with a final consolidating stage (query block); and
18) Repeat steps for every incoming query and the result block present in a dataset and engine blocks for disjoint paths.

In step 450, query planner 112 selects an optimum path from among the refined candidate paths. For example, this can be the path having the lowest path cost according to the path cost criteria. Control then proceeds to step 330 which uses the selected optimum path as the determined path.

Further examples of path determination that can be carried out in steps 410-450 as part of query planning are described below with respect to FIGS. 7-12.

Generating a User Specification and Creating a New Dataset

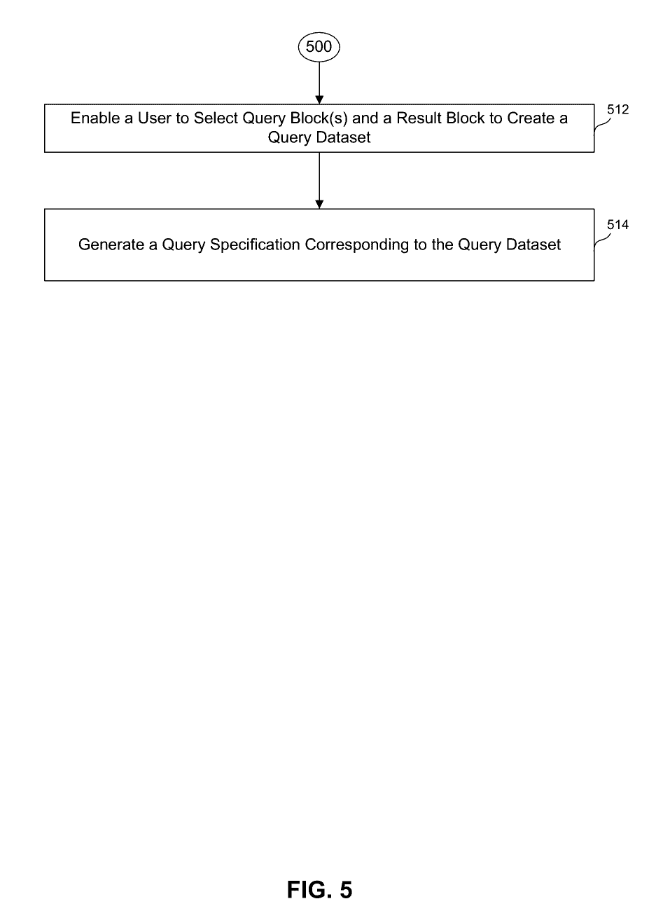

FIG. 5 is a flowchart illustrating a computer-implemented method 500 for enabling a user to input a query specification 114 according to an embodiment. In step 512, a user is enabled to select one or more query blocks and a result block for a new dataset. User interface 160 for example can provide a user interface element that allows a user to select a dataset. This selecting can include creating a new dataset, selecting an existing dataset, or editing an existing dataset according to a desired query. Such a user interface (UI) element can be a graphical UI panel, radio button, checkbox, text entry box, menu or other type of UI element.

In step 514, a query specification 114 is generated that corresponds to the new dataset. Query specification 114, for example, can identify a name or pointer to the new dataset. Query planner 112 can then use the name or pointer to access the dataset and identify the one or more query blocks and the result block.

Providing Graphical Representations To Facilitate Query Planning

FIG. 6 is a screen shot diagram illustrating a user interface display 600 that allows a user to create a new dataset. User interface display 600 is a graphical window having several areas or panels 610-650. Panel 610 allows a user to name a new dataset being created. Panel 620 displays a hierarchical list of tables available in one or more data sources. Panel 630 displays information on a block included in the dataset including associated dimension and measure knowledge models. In the example shown, panel 630 includes a result block having a category dimension knowledge model and a revenue measure knowledge model. Panel 650 shows a formula editor and description area.

In a further feature, panel 640 displays an intermediate graphical representation of a knowledge graph used in query planning. This graphical representation is based on the identified result block and can be displayed as a user creates the dataset according to an embodiment. In this way the user is given immediate visual feedback on the graph and knowledge models which will be used in query planning.

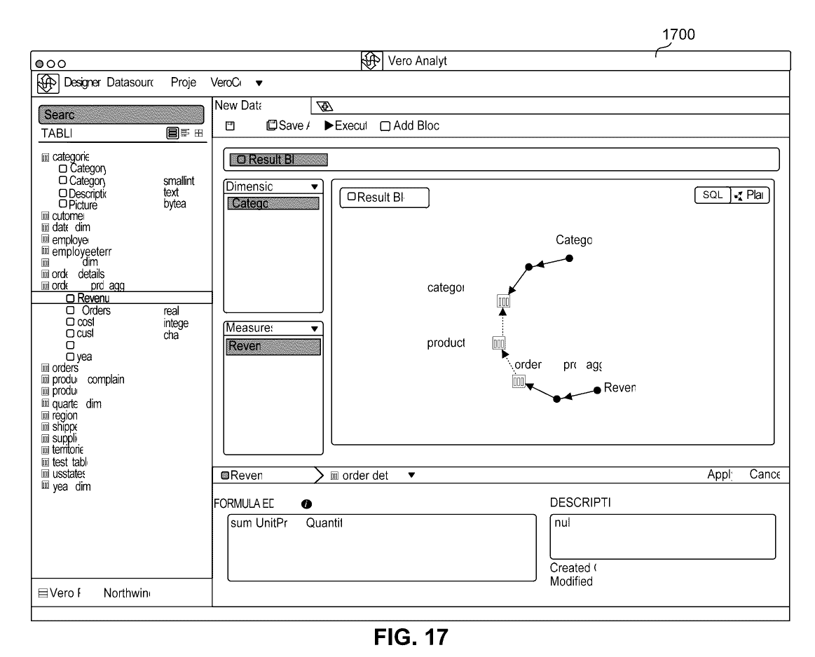

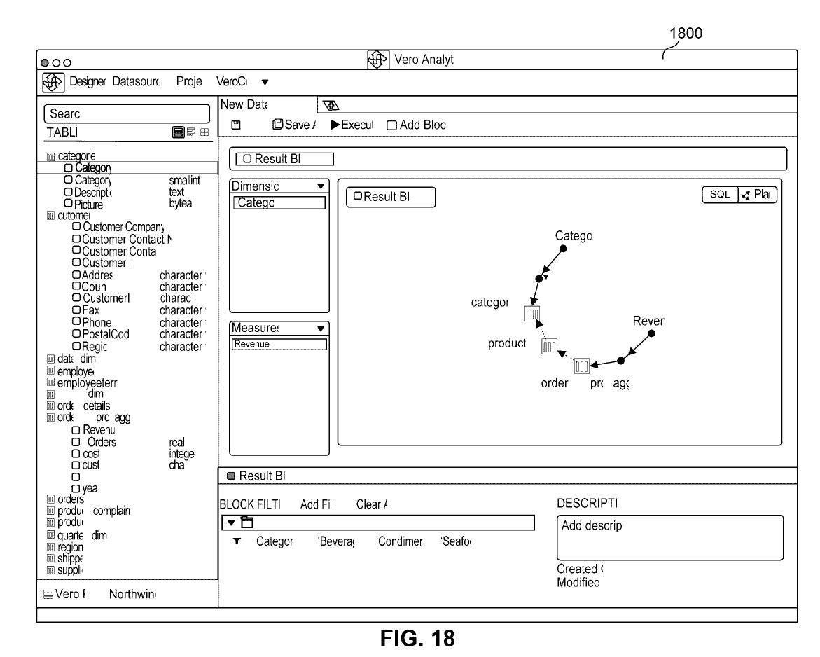

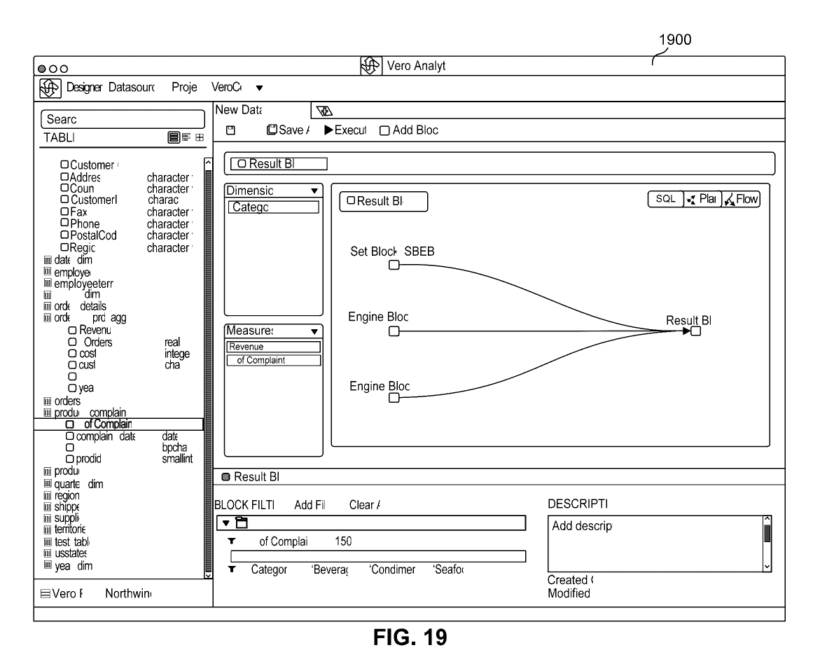

FIGS. 17-19 are further screen shot diagrams illustrating different user interface displays according to an embodiment. FIG. 17 shows a window 1700 with an intermediate graphical representation of a knowledge graph in a plan view for a result block used in query planning. FIG. 18 shows a window 1800 with an intermediate graphical representation of a knowledge graph in a plan view for the result block of FIG. 17 where further filtering criteria is selected in query planning. FIG. 19 shows a window 1900 with an intermediate graphical representation of a knowledge graph in a flow view for the result block of FIG. 17 where further filtering criteria is selected in query planning.

Further Examples of Path Determination for a Query Plan

FIGS. 7-12 illustrate further examples of path determination with and without disjoint paths that can be carried out to generate an efficient path to a dataset for a query plan. For brevity, references will be made to implementing these examples with respect to query planner 112 and steps 410-450 described above.

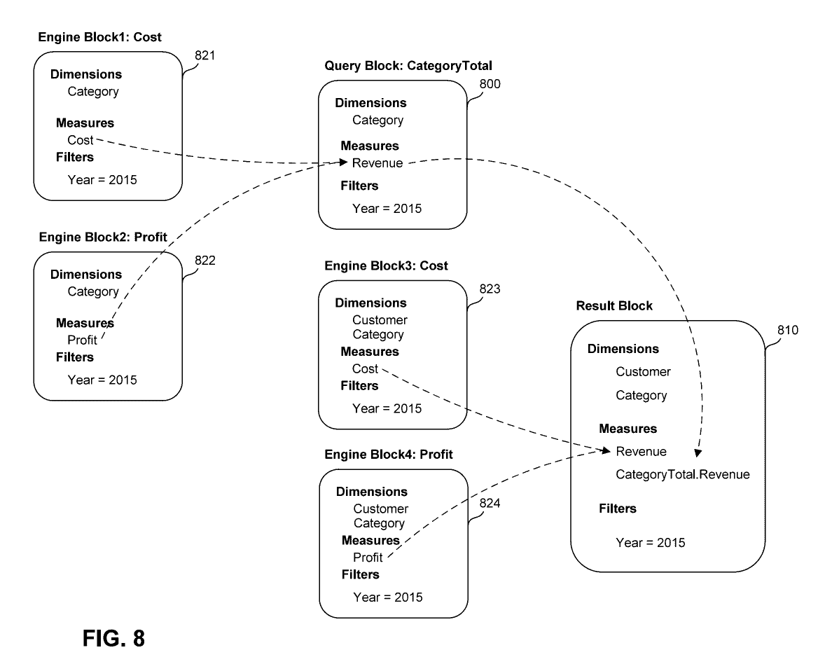

Consider the two examples of query block and result block processing and corresponding knowledge graphs (FIGS. 7-12). In one example, no disjoint paths between knowledge models of blocks are encountered (FIG. 7). In the other example, disjoint paths are encountered requiring engine blocks to be created (FIGS. 8-12).

In these two examples, query planner 112 operates on one or more query blocks, a result block, and engine blocks, if any. Each query block and result block is processed by query planner 112. A query block identifies one or more measure or dimension KMs. A query block can also include one or more filters, if any, are applied. A result block likewise can include one or more measure or dimension KMs, and one or more filters, if any, are applied. A result block also identifies a particular data source to which a data result is to be stored. When disjoint paths between KMs are encountered in query planning, engine blocks (also called set blocks) are created. In determining a path for a query plan, query planner 112 processes each engine block followed by each query block and the result block.

FIG. 7 is a diagram that illustrates a query block 700 and a result block 710 processed in query planning according to an embodiment. Query block 700 is for a category total query. Query block 700 identifies a dimension KM for a dimension (category), a measure KM for a measure (Revenue), and a filter for a dimension (Year) set to a filter value (2015).

For each query block (in this case query block 700), query planner 112 identifies a portion of a knowledge graph that includes projected Dimensions (Category), Measures (Revenue), and Filtered Dimensions (Year) (step 410). Query planner 112 then integrates any filters on Measures (Year=2015) (step 420). When determining candidate paths in step 430, query planner 112 processes any incoming block-to-block joins and related derived dimensions or derived measures. In this Category Total query block 700 there are no incoming block to block joins or derived dimensions or measures.

Result block 710 is processed similarly. Result block 710 identifies two dimension KMs for dimensions (Customer, Category), a measure KM for measure (Revenue), and a filter for a dimension (Year) set to a filter value (2015). Query planner 112 identifies a portion of a knowledge graph that includes projected Dimensions, Measures, and Filtered Dimensions KMs. Here there are two dimension KMs for dimensions (Customer, Category), a measure KM for measures (Revenue), and Filtered Dimension (Year). Query planner 112 then integrates any filters on Measures (Year=2015) (step 420).

When determining candidate paths in step 430, query planner 112 processes any incoming block-to-block joins and related derived dimensions or derived measures. Here there are no disjoint paths, however, a derived measure is found. CategoryTotal is incoming to the Result Block so query planner 112 identifies a derived Measure KM called CategoryTotal.Revenue and adds it to the Result Block 710.

FIG. 8 is a diagram that illustrates another example of a query block 800 and a result block 810 along with engine blocks 821-824 processed in a query plan with disjoint paths through a knowledge graph according to an embodiment. Here, the example of FIG. 7 is extended. Now a revenue expression Revenue=Cost+Profit applies.

Query planner 112 will process query block 800 and result block 810. Query planner 112 will encounter a disjoint plan and be forced to create sub blocks called engine blocks 821-824 to complete the query plan. Each of the engine blocks 821-824 has the same dimensionality as its respective source block (CategoryTotal 800) or Result Block 810.

In this case, the query planning steps are exactly the same as before but now query planner 112 generates a query plan for each engine block before the Query Block (CategoryTotal 800) or Result Block 810 is processed.

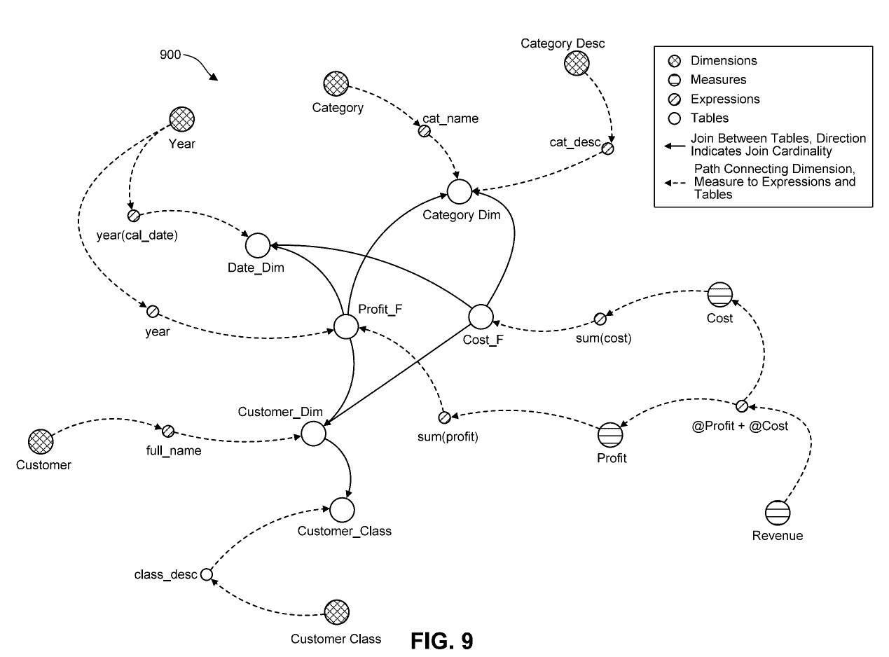

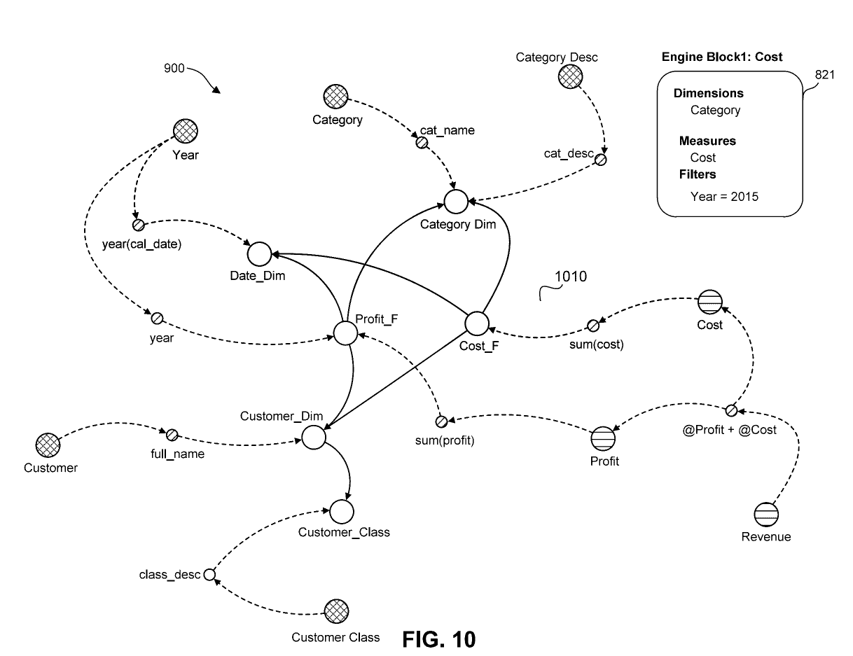

FIG. 9 shows an example knowledge graph 900 used in the example of FIG. 8 with joins and paths denoted. FIG. 10 shows an example traversal of a portion 1010 of knowledge graph 900 that gives rise to the disjoint paths in query planning for CategoryTotal Query Block 800 that requires processing an engine block 821 (Cost).

When applying the graphing algorithms to traverse knowledge graph 900 to identify candidate paths (step 430), query planner 112 encounters disjoint paths between paths for entity Profit and entity Cost. They are disjoint because there is no valid path connecting them. Valid paths are ones where the table path flows across a cardinality path that disallows many to many joins between fact or aggregate tables. This is because the aggregate values will be incorrect otherwise.

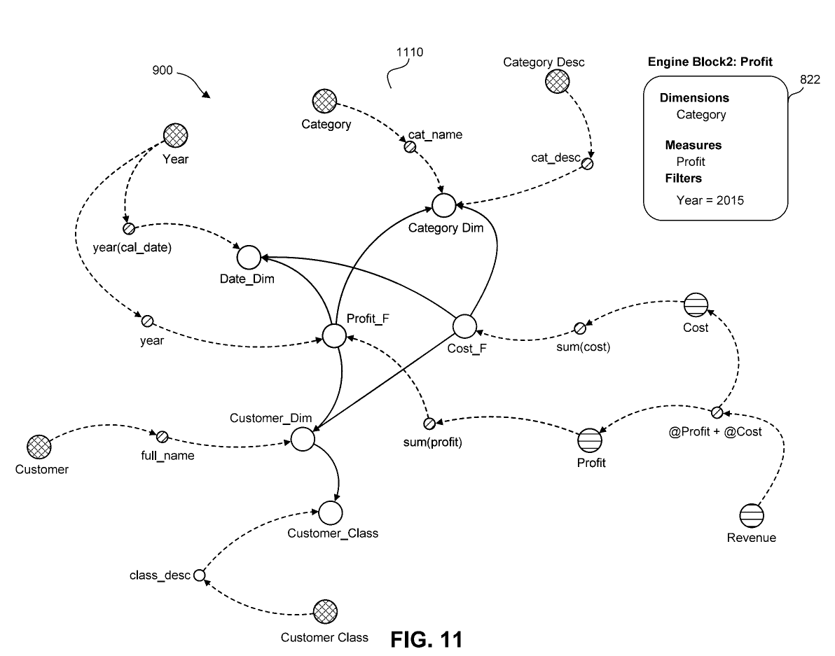

A Dimension or Measure KM can go to tables and tables join together via links of decreasing cardinality. For example, for every single category record in category_dim there are many category records in Cost_F as shown in FIG. 10 for engine block 821 (Cost). FIG. 11 shows an example traversal of a portion 1110 of knowledge graph 900 to process an engine block 822 (Profit) for a profit entity (Profit_F) in a query plan with disjoint paths.

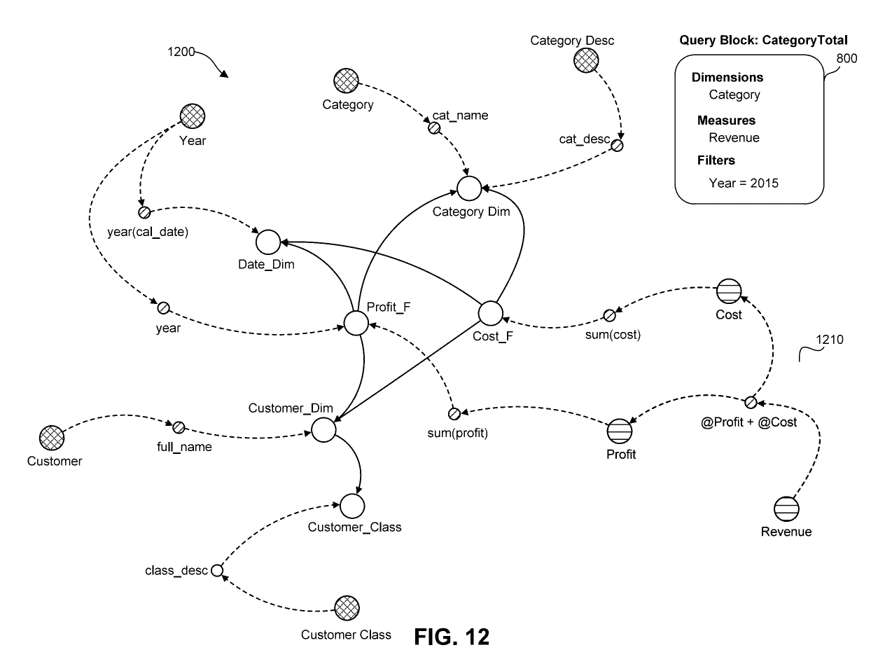

FIG. 12 shows an example traversal of the knowledge graph of FIG. 9 to process query block 800 for a total category entity in a query plan with disjoint paths. Query planner 112 assemble the disjoint plans for engine blocks 821-822 in the final phase of processing query block 800. Here parts of the formula not yet resolved are resolved. If query block 800 requested Profit and Cost as separate columns then there won't be any final Revenue formula, but will have the same number of engine blocks.

In an example, query planning for knowledge graph 900 then refines candidate paths and selects an optimum path based on path cost criteria in the following order of precedence:

1. Paths that contain table hints.

2. Paths with shortest distance between requested Dimensions and Measures.

3. Paths with the least cost.

4. Paths that support the maximum dimensionality requested.

5. Paths that would result in the least number of disjoint plans.

Expression Engine

In a further feature, an expression engine and computer-implemented methods are provided. In one embodiment, the expression engine is a learning engine that can automatically merge changes to existing knowledge models with little user intervention. The expression engine can digests new bits of knowledge and integrate it into a knowledge graph.

This process can occur in real-time as users drag and drop and define formulas related to a knowledge model, allowing users to learn quickly about the knowledge graph engine and the engine to learn from the user's inputs. This may happen simultaneously as a user defines a dataset and the user gets real-time query planning feedback in the form of actual SQL generated or query plan view. For example, where a user drags and drops columns from a table while defining a formula and renames the resultant measure or dimension, these changes are detected and provide sufficient knowledge to the expression engine to update a knowledge graph.

Also, knowledge models may be name-based entities and can accrete multiple expressions and paths for proper resolution.

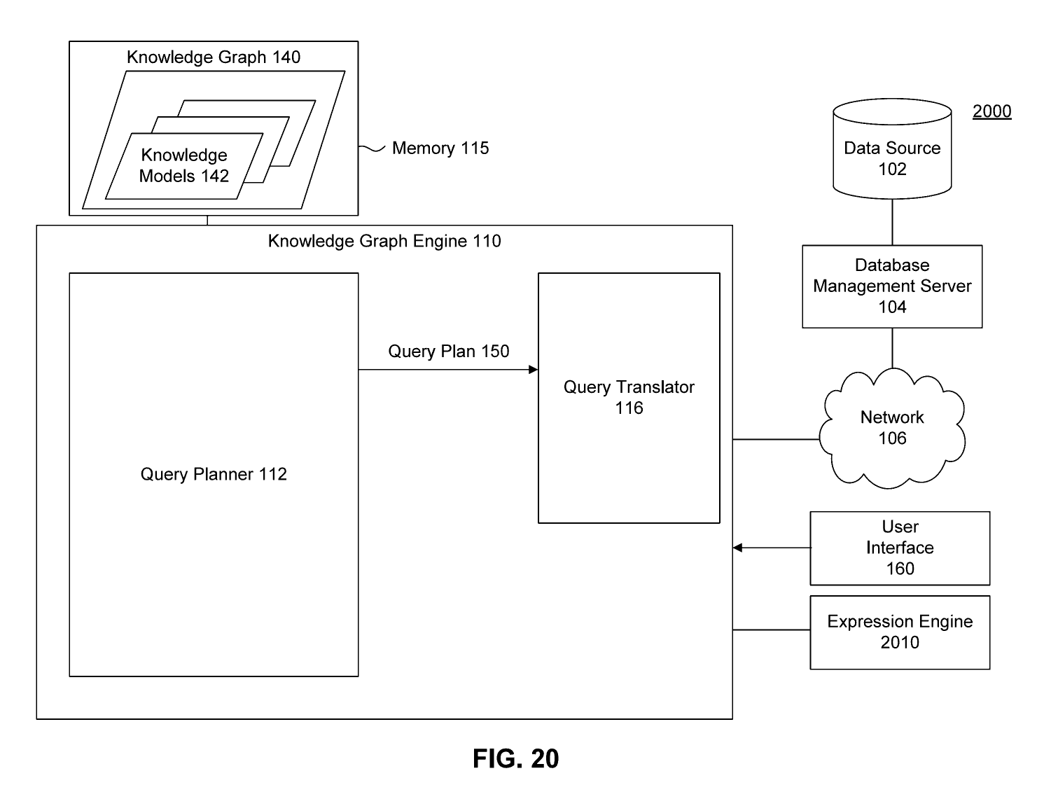

FIG. 20 is a diagram illustrating system 2000 having an expression engine 2010. In an embodiment, engine 2010 can be used with the knowledge graph engine 110 and other components of system 100 to generate data queries as described above. Expression engine 2010 receives a knowledge model and plans its integration into an overall knowledge graph. Unlike traditional business intelligence tools which put the responsibility of managing concepts purely in the hands of the user in a manual process, expression engine 2010 can deploy a series of heuristics and machine-assisted rules to insure the consistency and accuracy of a knowledge model without undue burden on the user.

For example, a user accidently creates redundant concepts with essentially the same meaning, or creates a duplicate named object but has a different meaning. In those cases, expression engine 2010 will attempt to automatically maintain consistency by automatically resolving conflicts. Another scenario where expression engine 2010 assists the user in key ways is when he or she needs to delete or replace a knowledge model that impacts dozens of datasets. Here, expression engine 2010 will auto-cascade such changes with little user intervention.

Possible Merge Scenarios:
1) Multiple Knowledge Models (KM) are created with the same name—automatically merge the complete definitions
2) Multiple KM are created with synonymous names—Vero uses its natural language cloud services determine the strength of similarity between the two names and creates a synonym KM or merges the definition
3) Completely different names but the same expression->ask user for merge or synonym creation.

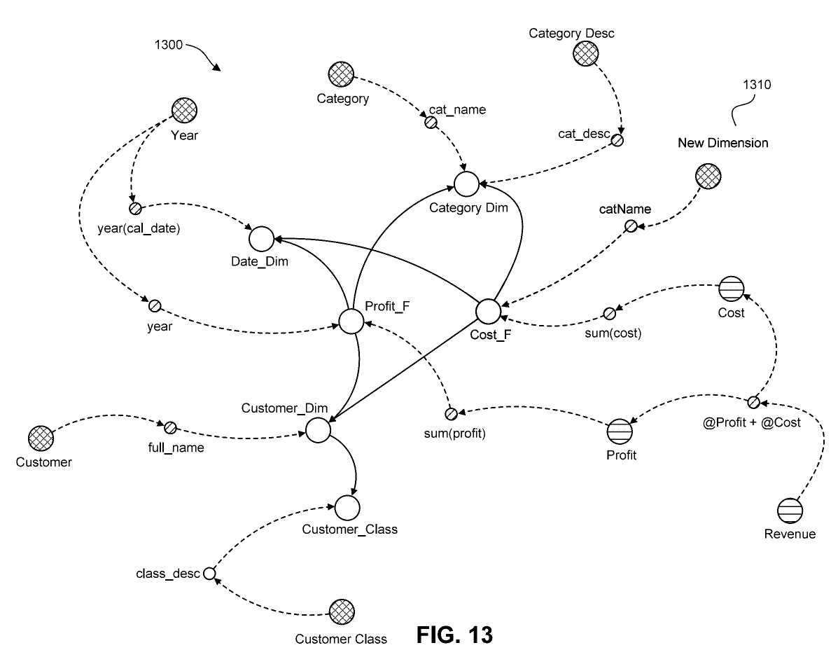

Further examples are discussed below with respect to the diagrams of FIGS. 13-19.

In the following example, a user creates a new Dimension with expression “catName” from the Cost_F table. Then when she names the Dimension Category one can see how the knowledge graph changes to accommodate the new expression.

FIG. 13 shows an example of a knowledge graph 1300 edited to include a new dimension entity (catName) shown in shaded area 1310. For example, a user creates a new dimension by drag and drop or manual creation with expression catName pointing to a table Cost_F

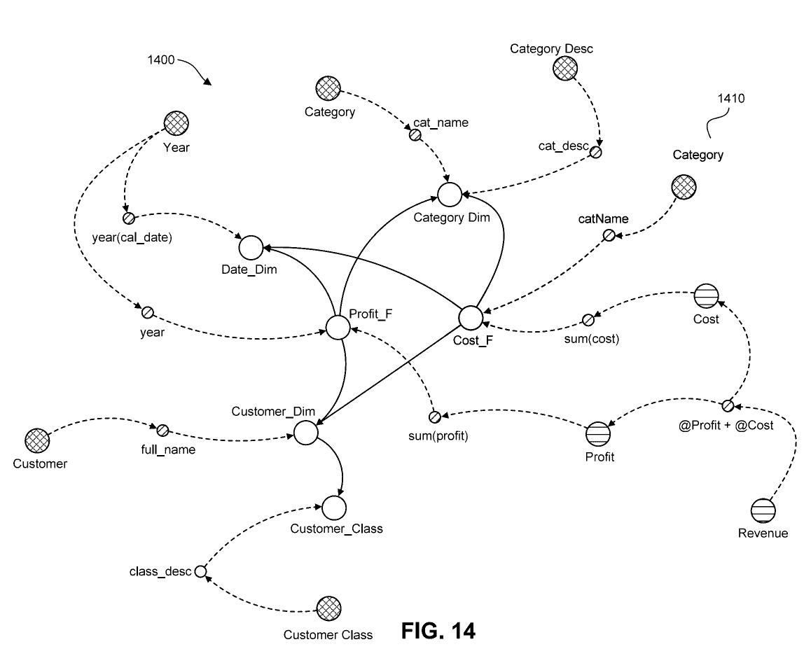

FIG. 14 shows an example of a knowledge graph 1400 edited to rename the new dimension entity (catName) to an existing entity name (Category) shown in shade area 1410. The rename action will cause expression engine 2010 to restructure the knowledge graph 1400.

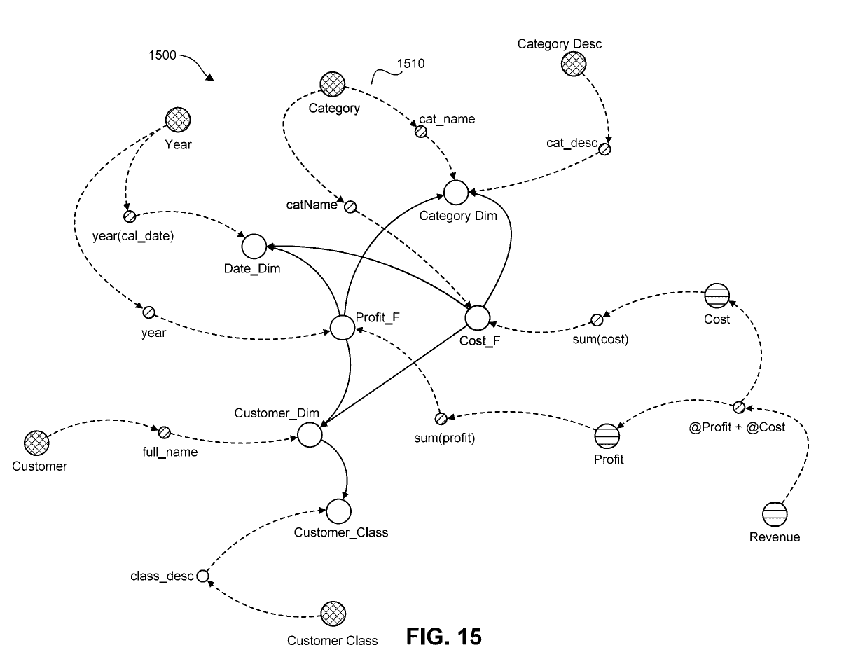

FIG. 15 shows an example of the knowledge graph edited to restructure the path for the new dimension entity (catName) to the existing entity (Category) shown in shaded area 1510 according to an embodiment. Expression engine 2010 restructures knowledge graph 1400 to that shown in graph 1500 having learned that Category has an alternative route between Category dimension and Cost_F table.

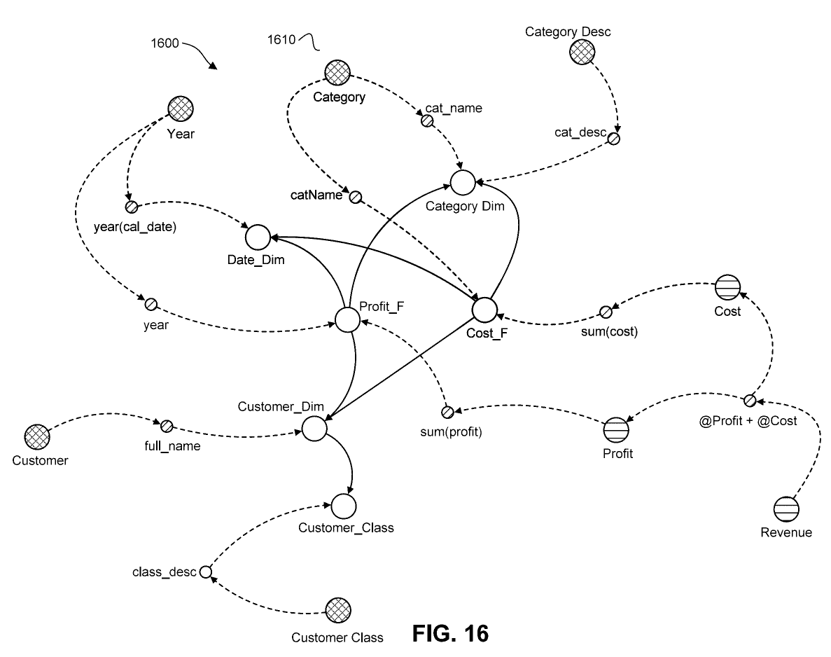

FIG. 16 shows how a query plan is updated to reflect a more efficient path over the edited knowledge graph 1600 according to an embodiment. In particular, the query plan is updated for engine block 821. Now, a more direct path shown in shaded area 1610 exists between Category and Cost_F. This allows a query to be generated more efficiently. The query plan is updated to reflect the change in the knowledge graph.

Expression engine 2010 can also detect when to restructure an existing knowledge model based on how an expression is defined and mapped to a table.

Finally, expression engine 2010 can detect when new paths should be created between tables in the event and an alias is needed. Aliases are needed when a single table must be joined to the same table multiple times to perform multiple roles. For example, if profit_f had order_date and ship_date, then the Date_dim table will have to be joined to profit_f twice when a request requires both Order Date and Ship Date in the result.

Collaboration Engine

In a further feature, a collaboration server (cloud or on premise) can be added to synchronize projects across the organization. When conflicting knowledge model scenarios arise a voting process is initiated where relevant users will be polled for the most correct definition. Knowledge model changes may also not have concrete effects on existing datasets without the approval of the owners/editors of affected datasets. A vote down or up of certain changes may be assimilated into a graph algorithm to choose better query plans, and votes are used to assess a user's accuracy around knowledge model subject areas. The voting can be implemented purely as the acceptance or rejection of a change to a dataset, or directly on the KM that is being changed.

Additional Example Computing Device Implementations

Various aspects of the disclosure including components of system 100 such as knowledge graph engine 110 can be implemented on a computing device by software, firmware, hardware, or a combination thereof. FIG. 21 illustrates an example computing device 2100 in which the contemplated embodiments, or portions thereof, can be implemented as computer-readable code. For example, the methods illustrated by flowcharts described herein can be implemented in computing device 2100. Various embodiments are described in terms of this example computing device 2100. After reading this description, it will become apparent to a person skilled in the relevant art how to implement the embodiments using other computer systems and/or computer architectures.

Computing device 2100 includes one or more processors, such as processor 2104. Processor 2104 can be a special purpose or a general purpose processor. Processor 2104 is connected to a communication infrastructure 2102 (for example, a bus or network). Processor 2104 may include a central processing unit (CPU), a Graphics Processing Unit (GPU), an Accelerated Processing Unit (APU), a Field-Programmable Gate Array (FPGA), a Digital Signal Processing (DSP), or other similar general purpose or specialized processing units.

Computing device 2100 also includes a main memory 2106, and may also include a secondary memory 2108. Main memory may be a volatile memory or non-volatile memory, and divided into channels. Secondary memory 2108 may include, for example, non-volatile memory such as a hard disk drive 2110, a removable storage drive 2112, and/or a memory stick. Removable storage drive 2112 may comprise a floppy disk drive, a magnetic tape drive, an optical disk drive, a flash memory, or the like. The removable storage drive 2112 reads from and/or writes to a removable storage unit 2116 in a well-known manner. Removable storage unit 2116 may comprise a floppy disk, magnetic tape, optical disk, etc. which is read by and written to by removable storage drive 2112. As will be appreciated by persons skilled in the relevant art(s), removable storage unit 2116 includes a computer usable storage medium having stored therein computer software and/or data.

In alternative implementations, secondary memory 2108 may include other similar means for allowing computer programs or other instructions to be loaded into computing device 2100. Such means may include, for example, a removable storage unit 2118 and an interface 2114. Examples of such means may include a program cartridge and cartridge interface (such as that found in video game devices), a removable memory chip (such as an EPROM, or PROM) and associated socket, and other removable storage units and interfaces which allow software and data to be transferred from the removable storage unit 2118 to computing device 2100.

In another embodiment, computing device 2100 may also include a memory controller. The memory controller may include functionalities to control data access to main memory 2106 and secondary memory 2108. In some embodiments, the memory controller may be external to processor 2104. In other embodiments, the memory controller may also be directly part of processor 2104. For example, many AMD™ and Intel™ processors use integrated memory controllers that are part of the same chip as processor 2104.

Computing device 2100 may also include a communication interface 2120. Communication interface 2120 allows software and data to be transferred between computing device 2100 and external devices. Communication interface 2120 may include a modem, a communications port, a PCMCIA slot and card, or the like. Software and data transferred via communication interface 2120 are in the form of signals which may be electronic, electromagnetic, optical, or other signals capable of being received by communication interface 2120. These signals are provided to communication interface 2120 via a communication path 2122. Communication path 2122 carries signals and may be implemented using wire or cable, fiber optics, a phone line, a cellular phone link, an RF link or other communications channels.

The communication interface 2120 allows the computing device 2100 to communicate over communication networks or mediums such as LANs, WANs the Internet, etc. The communication interface 2120 may interface with remote sites or networks via wired or wireless connections.

In this document, the terms “computer program medium,” “computer-usable medium” and “non-transitory medium” are used to generally refer to tangible media such as removable storage units 2116 and 2118, removable storage drive 2112, and a hard disk installed in hard disk drive 2110. Signals carried over communication path 2122 can also embody the logic described herein. Computer program medium and computer usable medium can also refer to memories, such as main memory 2106 and secondary memory 2108, which can be memory semiconductors (e.g. DRAMs, etc.). These computer program products are means for providing software to computing device 2100.

Computer programs (also called computer control logic) are stored in main memory 2106 and/or secondary memory 2108. Computer programs may also be received via communication interface 2120. Such computer programs, when executed, enable computing device 2100 to implement embodiments as discussed herein. In particular, the computer programs, when executed, enable processor 2104 to implement the disclosed processes, such as the steps in the methods illustrated by flowcharts discussed above. Accordingly, such computer programs represent controllers of computing device 2100. Where the embodiments are implemented using software, the software may be stored in a computer program product and loaded into computing device 2100 using removable storage drive 2112, interface 2114, hard disk drive 2110 or communication interface 2120, for example.

In yet another embodiment, computing device 2100 may also include input/output/display devices, such as keyboards, monitors, pointing devices, touchscreens, voice input, etc.

It should be noted that the simulation, synthesis and/or manufacture of various embodiments may be accomplished, in part, through the use of computer readable code, including general programming languages (such as C or C++), hardware description languages (HDL) such as, for example, Verilog HDL, VHDL, Altera HDL (AHDL), or other available programming and/or schematic capture tools (such as circuit capture tools). This computer readable code can be disposed in any known computer-usable medium including a semiconductor, magnetic disk, optical disk (such as CD-ROM, DVD-ROM). As such, the code can be transmitted over communication networks including the Internet. It is understood that the functions accomplished and/or structure provided by the systems and techniques described above can be represented in a core that is embodied in program code and can be transformed to hardware as part of the production of integrated circuits.

The embodiments are also directed to computer program products comprising software stored on any computer-usable medium. Such software, when executed in one or more data processing devices, causes a data processing device(s) to operate as described herein or, as noted above, allows for the synthesis and/or manufacture of electronic devices (e.g., ASICs, or processors) to perform embodiments described herein. Embodiments employ any computer-usable or -readable medium, and any computer-usable or -readable storage medium known now or in the future. Examples of computer-usable or computer-readable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nano-technological storage devices, etc.), and communication mediums (e.g., wired and wireless communications networks, local area networks, wide area networks, intranets, etc.). Computer-usable or computer-readable mediums can include any form of transitory (which include signals) or non-transitory media (which exclude signals). Non-transitory media comprise, by way of non-limiting example, the aforementioned physical storage devices (e.g., primary and secondary storage devices).

The Summary and Abstract sections may set forth one or more but not all exemplary embodiments as contemplated by the inventor(s), and thus, are not intended to limit the embodiments and the appended claims in any way.

The breadth and scope of the embodiments should not be limited by any of the above-described exemplary embodiments, but should be defined only in accordance with the following claims and their equivalents.

Identifiers, such as “(a),” “(b),” “(i),” “(ii),” etc., are sometimes used for different elements or steps. These identifiers are used for clarity and do not necessarily designate an order for the elements or steps.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer-implemented method for knowledge based query generation, comprising:
(a) storing electronically in memory a knowledge graph that represents relationships between a plurality of knowledge models;
(b) receiving a query specification that identifies a knowledge model for a query dataset;
(c) determining with a computing device a path based on path cost criteria, where the path covers a portion of the knowledge graph across one or more knowledge models to one or more data sources; and
(d) generating an initial query plan according to the one or more knowledge models along the determined path to fulfill the query specification with data from the one or more data sources.

2. The method of claim 1, further comprising translating the initial query plan to a final query plan expressed in one or more languages compliant with native languages of the respective one or more data sources used to fulfill the query dataset.

3. The method of claim 1, wherein each knowledge model describes (i) a name of a data entity that the knowledge model represents; (ii) a database table that provides data for the data entity; and (iii) a formula that describes how to transform data from the database table into data for the data entity wherein the user input specifies a measure knowledge model.

4. The method of claim 1, wherein the query specification identifies one or more dimension knowledge models and one or more measure knowledge models.

5. The method of claim 1, wherein determining the path based on the path cost criteria further includes examining input knowledge models and producing an efficient query using one or more of the following path cost criteria: 1) least number of disjointed sets, 2) lowest overall cost of query calculated by estimating the total number of records necessarily processed, 3) user directed or table hints, or 4) shortest distance graph algorithm between a totality of input knowledge models.

6. The method of claim 1, further comprising:
(e) determining that the path includes at least one disjoint set,
wherein the determining in step (c) comprises determining at least one query for each disjoint set determined in step (e).

7. The method of claim 1, wherein the query specification specifies a filter describing which data from the knowledge model to select.

8. The method of claim 5, wherein the determining (d) comprises determining a filtered dimension knowledge model for the filter.

9. The method of claim 1, wherein the knowledge graph represents at least one knowledge model in the plurality of knowledge models including another path to another knowledge model in the plurality of knowledge models, the other path describing a way to generate the data for a data entity based on the other knowledge model.

10. A program storage device tangibly embodying a program of instructions executable by at least one machine to perform a method for knowledge based query generation, said method comprising:
(a) storing electronically in memory a knowledge graph that represents relationships between a plurality of knowledge models;
(b) receiving a query specification that identifies a knowledge model for a query dataset;
(c) determining with a computing device a path based on path cost criteria, where the path covers a portion of the knowledge graph across one or more knowledge models to one or more data sources; and
(d) generating an initial query plan according to the one or more knowledge models along the determined path to fulfill the query specification with data from the one or more data sources.

11. A system for knowledge based query generation, comprising:
a computing device;
a memory that stores a knowledge graph that represents relationships between a plurality of knowledge models;
a knowledge graph engine, implemented on the computing device, that receives a query specification specifying at least one knowledge model in the knowledge graph for a query dataset; and
a query planner, implemented on the computing device, that determines a path based on path cost criteria, wherein the path covers a portion of the knowledge graph across one or more knowledge models to one or more data sources, and generates an initial query plan according to the one or more knowledge models along the determined path to fulfill the query specification with data from the one or more data sources.

12. The system of claim 11, further comprising a query translator, implemented on the computing device, that translates the initial query plan to a final query plan expressed in one or more languages compliant with native languages of the respective one or more data sources used to fulfill the query dataset.

13. The system of claim 11, wherein the query specification specifies a measure knowledge model.

14. The system of claim 11, wherein the query specification specifies a dimension knowledge model.
